(19) United States
(12) Patent Application Publication
(10) Pub. No.: US 2025/0360460 A1
(43) Pub. Date: Nov. 27, 2025

(54) Atmospheric Water Harvester With High Efficiency, And Methods Of Using Thereof

(71) Applicant: Water Harvesting, Inc., Fremont, CA (US)

(72) Inventors: Taber Hardesty Smith, Fremont, CA (US); David S. Kuo, Fremont, CA (US); Ievgen Kapustin, Fremont, CA (US); Bruno Marchon, Fremont, CA (US); Faisal Shafikurrehman Maniar, Fremont, CA (US)

(73) Assignee: Water Harvesting, Inc., Fremont, CA (US)

(21) Appl. No.: 19/295,169

(22) Filed: Aug. 8, 2025

Related U.S. Application Data
(63) Continuation of application No. 17/797,969, filed on Aug. 5, 2022, now Pat. No. 12,390,760.
(60) Provisional application No. 62/976,824, filed on Feb. 14, 2020.
(60) Provisional application No. 63/053,428, filed on Jul. 17, 2020.

(51) Int. Cl. B01D 53/26; B01D 5/00; B01D 53/06; B01D 53/08; B01D 53/28; E03B 3/28

(52) U.S. Cl. CPC B01D 53/261; B01D 5/0006; B01D 53/06; B01D 53/08; B01D 53/265; B01D 53/28; E03B 3/28; B01D 2253/204; B01D 2257/80; B01D 2259/40096

(57) ABSTRACT

Provided herein are water harvesting systems, as well as methods using such systems for capturing water from surrounding air. The systems and methods use water capture materials to adsorb water from the air. For example, the water capture materials may be metal-organic-frameworks. The systems and methods desorb this water in the form of water vapor, and the Water vapor is condensed into liquid water and collected. The liquid water is suitable for use as drinking water.

### CROSS-REFERENCE TO RELATED APPLICATION

This application claims priority to U.S. Provisional Patent Application No. 62/976,824, filed Feb. 14, 2020, and U.S. Provisional Patent Application No. 63/053,428, filed Jul. 17, 2020, each of which is incorporated herein by reference in its entirety.

### FIELD

The present disclosure relates generally to water harvesting, and more specifically to systems and methods for harvesting water from surrounding air using metal-organic-frameworks and/or other water capture materials.

### BACKGROUND

A large percentage of the world's population is experiencing water shortages. The water in the form of vapor and droplets in the atmosphere is a natural resource that could be used (address the global water problem. Dewing from moist air and fog capture are examples of attempts to capture water from air. but such processes require either frequent presence of 100% relative humidity or a large amount of energy. Thus, such processes are not commercially viable solutions for capture of water from air. See generally Kim et al., Science 356, 430-434 (2017).

What is desired in the art are commercially viable systems and methods that can harvest water from surrounding air with minimum energy requirements and that can be powered by low-grade energy sources (e.g., sunlight).

### BRIEF SUMMARY

In some aspects, provided is a water harvesting system for capturing water from surrounding air, comprising: an adsorption/desorption unit, at least one condenser, and at least one air-circulating unit. In some embodiments, the adsorption unit comprises a plurality of modules and a mode-shifting structure.

In some embodiments, the plurality of modules are configured such that at least one module operates in adsorption mode concurrently as at least one of the remaining modules operates in desorption mode, wherein each module comprises at least one structural element, wherein at least a portion of each structural element supports at least one water capture material, wherein the at least one water capture material adsorbs water from surrounding air when the module is in adsorption mode, and desorbs water in the form of water vapor when the module is in desorption mode.

In some embodiments, the mode-switching structure is configured to concurrently switch at least one module from adsorption mode to desorption mode and at least one module from desorption mode to adsorption mode. In some embodiments, the mode-switching structure comprises a rotating mechanism, wherein the plurality of modules are connected to the rotating mechanism and arranged in a rotary configuration.

In some embodiments, the at least one condenser is positioned in proximity to the at least one module in desorption mode, and configured to condense water vapor into liquid water.

In some embodiments, the at least one air-circulating unit is configured to draw surrounding air into each module in adsorption mode, thereby assisting adsorption of water by the at least one water capture material from the surrounding air.

In some aspects, provided is a water harvesting system for capturing water from surrounding air, comprising: an adsorption/desorption unit, at least one condenser, and at least one air-circulating unit.

In some variations, the adsorption/desorption unit comprises at least one structural clement, wherein at least a portion of each structural element supports at least one water capture material, wherein the at least one water capture material adsorbs water from surrounding air when in adsorption mode, and desorbs water in the form of water vapor when in desorption mode. In some embodiments, the at least one structural element is a conductive element, and the conductive element is resistively heated by flowing electricity to facilitate desorption of water from the water capture material coated on the conductive element.

In some embodiments, the at least one condenser is positioned in proximity to the at least one structural element, and configured to condense water vapor into liquid water.

In some embodiments. the at least one air-circulating unit is configured to simultaneously (i) draw surrounding air into the at least one module operating in adsorption mode, thereby assisting adsorption of water by the at least one water capture material in the module from the surrounding air, and (ii) circulate air to cool the at least one condenser.

In some aspect, provided is a water harvesting system for capturing water from surrounding air, comprising an adsorption/desorption unit, at least one condenser, and at least one air-circulating unit. In some embodiments. the adsorption/desorption unit comprises a plurality of modules arranged in a rotary configuration, and a rotating mechanism.

In some embodiments, each modole comprises at least one conductive element, wherein at least a portion of each conductive element is coated with at least one water capture material, wherein the at least one water capture material adsorbs water from surrounding air when the module is in adsorption mode. and desorbs water in the form of water vapor when the module is in desorption mode.

In some embodiments, the plurality of modules are mounted onto the rotating mechanism, and configured to concurrently switch at least one module from adsorption mode to desorption mode and at least one module from desorption mode to adsorption mode.

In some embodiments. the at least one condenser is positioned in proximity to the at least one module in desorption mode, and configured to condense water vapor into liquid water.

In some embodiments, the at least one air-circulating unit is configured to draw surrounding air into each module in adsorption mode and circulate the air in the adsorption/desorption unit, thereby assisting adsorption of water by the at least one water capture material from the surrounding air.

### DESCRIPTION OF THE FIGURES

The present application can be best understood by reference to the following description taken in conjunction with the accompanying figures included in the specification. The figures herein are not drawn to scale.

FIG. 1 depicts an exemplary plate-like structural element coated with water capture material.

FIGS. 2A and 2B depict air flow through a plurality of exemplary structural elements coated with water capture material.

FIG. 3A depicts an exemplary module containing a plurality of structural elements coated with water capture material held together by a frame. FIGS. 3B and 3C (exploded view) depict an exemplary adsorption/desorption unit made up six modules arranged in a rotary configuration and mounted onto a rotating base (rotary carousel).

FIG. 4A depicts an exemplary arrangement of modules in a rotary configuration. In this figure, modules 1-5 are in adsorption mode, and modole 6 is in desorption mode. FIG. 4B depicts a table showing the mode of each module in each exemplary step. For example, module 2-6 are in adsorption mode and module 1 is in desorption mode in step 6.

FIGS. 5A and 5B depict an exemplary water harvesting system with a rotary structure or carousel. FIGS. 5C and SD depict exemplary circulating ambient temperature condensers, with an exploded view of the setup on the right side of each figure.

FIG. 6 depicts an exemplary plate-like structural element coated with water capture material undergoing desorption.

FIG. 7 depicts an exemplary process of adsorption, desorption and condensation using the water harvesting systems described herein to collect water from the atmosphere.

FIGS. 8A, 8B, and 8C depict graphs showing changes in the weight of a module in an exemplary water harvesting system. FIG. 8A depicts an increase in the weight of the module in adsorption mode. FIG. 8B depicts a decrease in the weight of the module in desorption mode. FIG. 8C depicts weight changes of a module during multiple adsorption/desorption cycles.

FIG. 9 depicts a graph showing relative water uptake with an exemplary water harvesting system, measured at various time points over the course of more than 1,000 adsorption/desorption cycles.

FIG. 10 depicts an exemplary schematic of parameters considered in designing and arranging structural elements to allow for diffusion of water from surrounding air to a water capture material. This drawing is not to scale.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

In some aspects, provided herein are water harvesting systems for capturing water from surrounding air. In some embodiments, the systems include at least an adsorption/desorption unit, at least one condenser, and at least one air-circulating unit. The adsorption/desorption unit bas a plurality of modules that contain water capture material. When the system is operating in steady state, at least one of the modules is in adsorption mode, and simultaneously, at least one of the remaining modules is in desorption mode. In adsorption mode. water capture material in a given modole adsorbs water from surrounding air. The air-circulating unit draws surrounding air into each module in adsorption mode, thereby assisting adsorption of water by the water capture material from the surrounding air, Then, when the module switches into desorption mode, the module desorbs water in the form of water vapor or steam.

In certain aspects, the systems provided herein further include a mode-switching structure that switches at least one module from adsorption mode to desorption mode, and at least one of the remaining modules from desorption mode to adsorption mode. In some variations, the mode-switching structure is a rotary structure on which the plurality of modules are mounted onto. The rotary structure rotates to shift at least one module from adsorption mode to desorption mode, and at least one of the remaining modules from desorption mode to adsorption mode.

Once water is desorbed from a given module in desorption mode, the water vapor is condensed into liquid water via at least one condenser positioned in proximity to the at least one module in desorption mode. The liquid water can then be collected by a storage tank. In some variations, the systems described herein further include at least one steam-redirecting unit that redirects water vapor desorbed from a given module in desorption mode to the condenser.

In other aspects, provided herein are also water harvesting systems for capturing water from surrounding air, comprising: an adsorption/desorption unit, at least one condenser. and at least one air circulating unit that simultaneously (i) draws surrounding air into the at least one module operating in adsorption mode, thereby assisting adsorption of water by the at least one water capture material in the module from the surrounding air, and (ii) circulates air to cool the at least one condenser. Effectively, the surrounding air drawn in by the air-circulating unit could be recirculated or recycled to achieve at least two different purposes adsorbing water and cooling the condenser.

The water harvesting systems described herein increase the efficiency and simplicity of water harvesting. In some aspects, the time for each adsorption/desorption cycle can be shortened. In some embodiment, a compressor becomes unnecessary, making the operation less noisy and less expensive. In other aspects, simultaneous adsorption/desorption enables more efficient design of the water harvesting systems. In some variations. the systems described herein do not require a compressor or a separate cooling mechanism, a gate valve, a chamber, or a vacuum pump.

In other aspects, provided herein are also methods of capturing water from surrounding air using the systems provided herein. In some embodiments, the methods comprise; adsorbing water from surrounding air in at least one module in adsorption mode; desorbing at least a portion of water in at least one of the remaining modules in desorption mode; condensing at least a portion of the water vapor release from the at least one module in desorption mode using the at least one condenser to produce liquid water, wherein adsorbing, desorbing, and condensing occur concurrently; and switching at least one module in adsorption mode to desorption mode and at least one of the remaining modules in desorption mode to adsorption mode.

In some embodiments, the methods comprise: drawing surrounding air into at least one module in adsorption mode to assist adsorption of water by the at least one water capture material and to assist cooling of the at least one condenser, wherein the air is recirculated or recycled to assist both adsorption and cooling, heating at least one of the remaining modules in desorption mode to assist desorption of at least a portion of water from the at least one water capture material, and condensing at least a portion of the water vapor release from the at least one module in desorption mode using the at least one condenser to produce liquid water.

In some embodiments, the methods comprise: adsorbing water from surrounding air in at least one module in adsorption mode, desorbing at least a portion of water in at least one of the remaining modules in desorption mode, condensing at least a portion of the water vapor release from the at least one module in desorption mode using the at least one condenser to produce liquid water, wherein adsorbing, desorbing, and condensing occur concurrently; and rotating at least one module in adsorption mode to desorption mode and at least one of the remaining modules in desorption mode to adsorption mode.

The systems, and methods of using such systems for water harvesting, are described in further detail below.

### Adsorption/Desorption Unit

In some embodiments, water harvesting systems for capturing water from surrounding air comprises an adsorption/desorption unit. In some embodiments, the adsorption/desorption unit comprises a plurality of modules and a mode-switching structure.

### Modules

In some embodiments, the plurality of modules are configured such that at least one module operates in adsorption mode concurrently as at least one of the remaining modules operates in desorption mode. In some embodiments, the plurality of modules are arranged in a rotary configuration. In some embodiments, the plurality of modules are connected to or mounted on a rotating base.

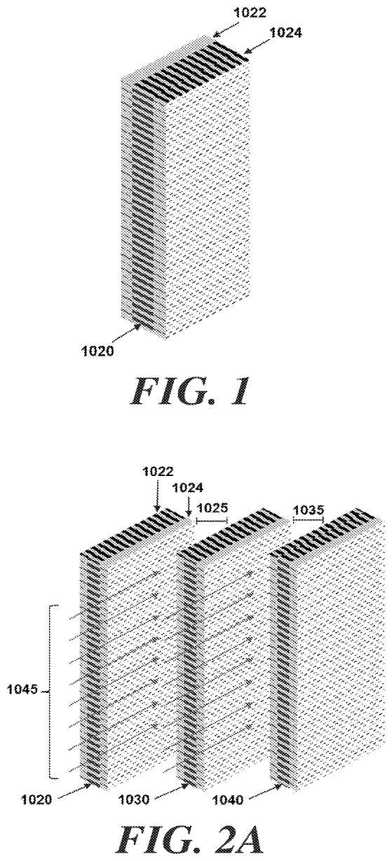

In some embodiments, each module comprises at least one structural element. With reference to FIG. 1, exemplary plate-like structural element 1020 is coated by adsorbing layers 1022 and 1024. Structural element 1020 supports water capture material coated on both sides of the structural element, where the structural clement is a beating substrate that can be heated, e.g., by flowing electricity. It should be understood that, in certain variations, each adsorbing layer may have the same or different water capture material. In other variations, each adsorbing layer may have the same or different thickness. In yet other variations, only one side of the structural element is coated by an adsorbing layer.

In some embodiments, the adsorption/desorption unit is configured to directly heat the at least one structural element, which may minimize waste heat. In some embodiments, the at least one structural element is a conductive element. In some embodiments, the conductive element is resistively heated by flowing electricity to the conductive element. In some embodiments, the conductive element is a metal or a metal plate.

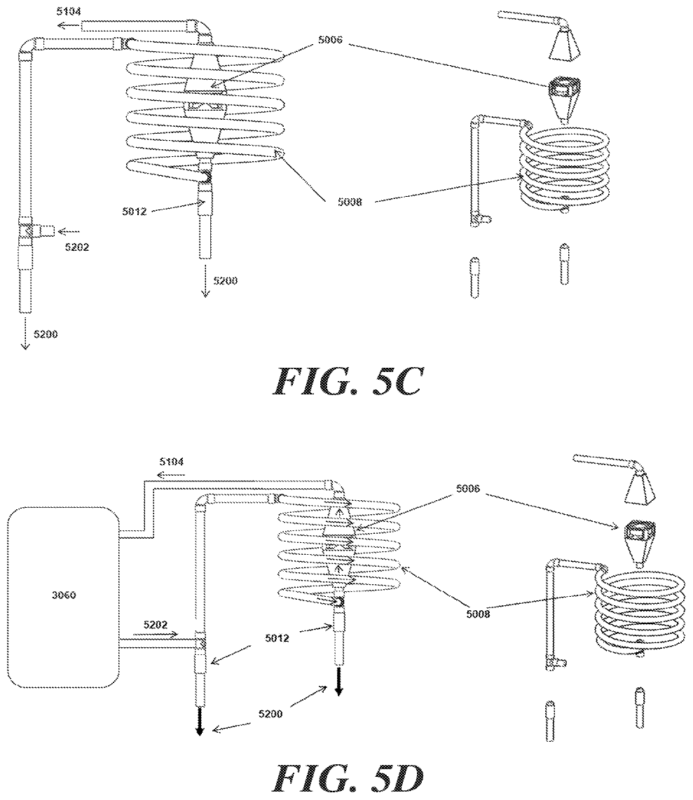

With reference to FIG. 6, structural element 1020 is a conductive element (or resistive substrate). During desorption, structural element 1020 is resistively heated by flowing electricity 6000 through it, thereby assisting desorption of water, in the form of steam 6100, from adsorbing layers 1022 and 1024, made up of water capture material, coated on conductive element 1020.

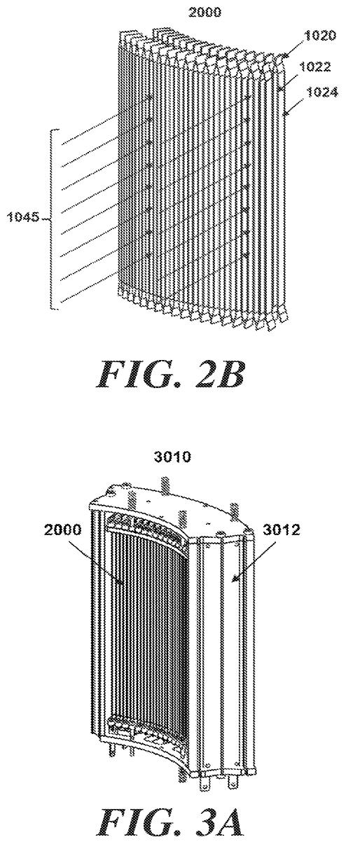

With reference to FIGS. 2A and 2B, air flow is depicted flowing into an adsorption/desorption unit, through the gaps between adjacent structural elements. During adsorption, surrounding air flows through the gaps of adjacent structural elements, allowing the adsorbing layers to adsorb water from surrounding air. FIG. 2A depicts a plurality of exemplary plate-like structural elements 1020, 1030 and 1040 arranged in parallel, with gaps (1025 and 1035) between adjacent structural elements (1020 and 1030; and 1030 and 1040, respectively) with air (represented by set of arrows 1045) flowing in between the gaps. FIG. 2B depicts a plurality of exemplary plate-like structural elements (2000) arranged radially, with gaps between adjacent structural elements and air (represented by set of arrows 1045) flowing in between the gaps. As depicted in this figure, each structural element is a heating substrate coated on both sides with adsorbing layers. For example, structural element 1020 is coated on both sides with adsorbing layers 1022 and 1024. It should be understood that, in certain variations, each adsorbing layer may have the same or different water capture material. In other variations, each adsorbing layer may have the same or different thickness. In yet other variations, only one side of the structural element is coated by an adsorbing layer.

In some embodiments, electrical power applied to the conductive element can be tailored to optimize desorption time, as the rate of water desorption dm/dt is related to the electrical power W by the following equation, with E [symbol] being the heat of adsorption of water into the water capture material or the MOP layer:

$$\frac{dm}{dt} = \frac{W}{{ε}_{ads}} \qquad Equation ( 1 )$$

The electrical resistance of the substrate R. as well as the current/flowing through it can therefore be tuned for optimum desorption rate, since the power W is related to R and l through the following equation:

$$W = {RI}^{2} \qquad Equation ( 2 )$$

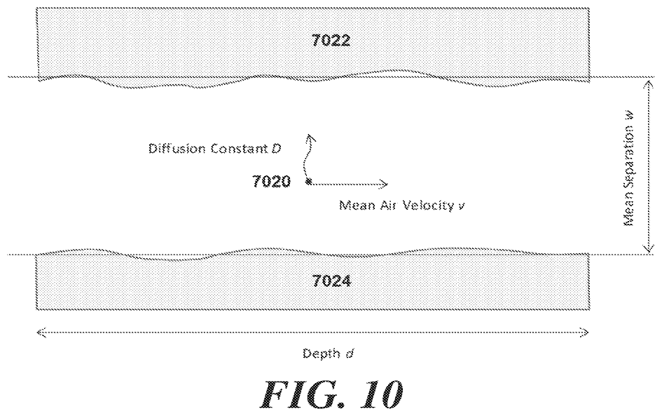

In some embodiments, the structural elements are designed and arranged to allow for diffusion of water from surrounding air to the water capture material during the adsorption phase. With reference to FIG. 10, layers 7022 and 7024 of water capture material are coated on adjacent structural elements, and exemplary air molecule 7020 is shown as a dot passing through the gap between those structural elements. In some embodiments, with reference again to FIG. 10, the structural elements are designed and arranged in a way such that d/v>c×(w/2)²/D, where (i)d is the depth of travel by air (excluding water vapor) through the gap between the structural elements during the adsorption phase, (ii) v is the mean velocity of air (carrying water vapor) through the structural elements during the adsorption phase, (ii) c is a constant, (iv) w is the mean separation between water capture material layers 7022 and 7024 on adjacent structural elements, and (v)D is the diffusion constant or diffusivity of water vapor.

In d/v>c×(w/2)²/D. the left side of the inequality notation, i.e., d/v, may be referred to as the “transit time” and denoted as t_{Trans}. The right side of the inequality notation without the constant c, i.e., (w/2)²/D, may be referred to as the “diffusion time” and denoted as t_{Diff}. The condition d/v>e×(w/2)²/D can be equivalently written as t_{Trans}>c×t_{Diff}, or stated as that the transit time of air molecules is greater than a certain percentage of the diffusion time of water vapor. For example, if c is 30%, the structural elements are arranged such that the transit time is greater than 30% of the diffusion time.

In some variations, the constant e is at least about 5%, at least about 10%, at least about 30%, at least about 50%, or at least about 75%; or between about 1% and about 5%. between about 5% and 50° C., between about 10% and about 509%, between about 30% and about 75%, or between about 50% and 150%.

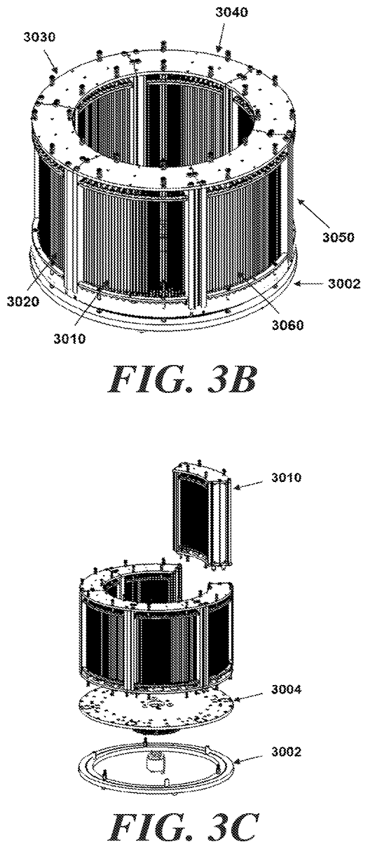

In some embodiment, the structural elements are arranged radially, in series, or in parallel, to form a module. In some embodiments, the structural elements are welded together, soldered together, held in compression together, or electrically connected by any other means. With reference to FIG. 3A, example module 3010 includes a plurality of plate-like structural elements 2000 coated with water capture material and arranged radially, held together by frame 3012.

In some embodiments. the structural elements are flexible. In some embodiments, the structural elements are held in tension, in order to maintain even spacing and preventing the elements from contacting one another. In some embodiments, the tensioning mechanism is a whiffle tree or whippletree. In some embodiments, the whippletree is formed by one or more flexible members,

In some embodiments, the plurality of modules are configured in such a way as to form a cylinder. With reference to FIG. 3B and 3C, exemplary adsorption/desorption unit 3000 includes six modules (3010, 3020, 3030, 3040, 3050, and 3060) arranged in a rotary configuration and mounted onto mode-switching structure 3002 (FIG. 3B). The mode-switching structure depicted here is a rotary carousel. As depicted in the exploded view of FIG. 3C, mode-switching structure 3002 includes rotating base 3004. While six modules are depicted in the exemplary adsorption/desorption unit of FIGS. 38 and 3C, it should be understood that, in other variations, the adsorption/desorption unit may include any number of modules within the plurality of modules.

In some embodiments, the modules are rotated in such a way that one or more of the modules are moved into an area of desorption and one or more of the modules are moved into an area of adsorption. In some embodiments, the rotation of the modules is performed by a rotating plate driven by a motor through a belt. In some embodiments, the rotation of the modules is performed by a rotating plate driven by a motor through a system of one or more gears.

In some embodiments, the at least one structural element is at least one plate. In some embodiments, the at least one plates are arranged radially or parallel to each other within the module. In some embodiments, the at least one plates are each independently coated on one or both sides with the water capture material.

In some variations, the plates are arranged radially or parallel to each other and a gap exists between adjacent plates. The plates may be made of any suitable material, including any suitable metal. For example, in some variations, the plates comprise aluminum. In some variations, the plates comprise solid metal. In one variation, the places are in the shape of fins.

In certain variations, the plates have a flat surface. In other variations, each plate has a cellular design where its surface is crisscrossed with small channels in a grid pattern, so as to make water capture material areas (e.g., squares) that would allow for thermal expansion mismatch between the plates and the water capture material. In other variations, each plate bas a surface textured with topographic features that can enhance water adsorption/desorption performance and/or reliability. In one variation, the topographic features are holes, bumps, ridges, or grooves, or any combination thereof. In another variation, the plates include mesh. For example, in one variation, the plates include aluminum mesh.

In some embodiments, the distance of the gap between adjacent plates relative to the length of each plate achieves optimal air flow and maximizes water adsorption. In some variations the gap between adjacent plates is about 1% to about 5% of the length of a plate.

In some embodiments, the plates are coated with layers of the water capture material each having a thickness between about 10 microns to about 500 microns, or between about 50 microns to 500 microns, or between about 10 microns to about 50 microns. The thickness of the layer may allow for faster adsorption and desorption (e.g., as compared to thicker layers). In other embodiments, the plates are coated with layers of the water capture material each having a thickness of about 0.1 to about 1 cm. Such thickness of the layer may allow for production of larger water quantities (e.g., as compared to thinner layers).

In certain embodiments, each layer of the water capture material on the plates has a porosity. In some variations, the porosity is at least about 409%, at least about 509%, at least about 60%, at least about 70%, or at least about 80%; or between about 40% and about 90%, between about 50% and 90%, between about 405% and about 80%, between about 50% and about 80%, or between about 60% and 80%. In other embodiments, the layer of the water capture material is non-porous.

In some embodiments, the ratio of the thickness of the layer of the water capture material is greater than the thickness of a plate. In certain embodiments where both sides of the plates are coated with the water capture material, the ratio of the thickness of the first (e.g., top) layer of the water capture material to the thickness of the plate to the thickness of the second (e.g., bottom) layer of the water capture material optimizes desorption of water and energy used to heat the plates in the chamber. In some variations, where the layers are non-porous, the thickness of each layer of the water capture material may be at least greater than half of the plate thickness.

In some variations of the foregoing, the layers of the water capture material may be mixed with one or more additional components. In some variations, a binder may be mixed into the layer. In certain variations, an organic binder may be used. In certain variations, silicone binder may be used. In one variation, a silicone resin binder may be used. In certain variations, the layer may further comprise one or more materials to help with thermal conductivity, to speed up transfer. In one variation, the layer further comprises graphite.

In certain variations, the water capture material is uniformly distributed on the plates. Any writable techniques known in the art may be employed to coat the layers of the water capture material on the plates. For example, in one variation, the layers of water capture material are deposited onto the plates.

### b) Water Capture Material

In some embodiments, at least a portion of each structural element supports at least one water capture material. In some embodiments, at least a portion of each structural element is coated with at least one water capture material. In some embodiments, at least one water capture material adsorbs water from surrounding air when the module is in adsorption mode, and desorbs water in the form of water vapor when the module is in desorption mode.

In some variations, the water capture material comprises metal-organic frameworks (MOFs). MOFs are porous materials that have repeating secondary building units (SBUs) connected to organic ligands. In some variations, the SBUs may include one or more metals or metal-containing complexes. In other variations, the organic ligands have acid and/or amine functional group(s). In certain variations, the organic ligands have carboxylic acid groups.

Any suitable MOFs capable of adsorbing and desorbing water may be employed in the systems provided herein. In one variation, MOF-303 may be used, which has a structure of AK (OH) (HPDC), where HPDC stands for 1H-pyrazole-3,5-dicarboxylate (which may also be referred to as 3,5-PyxDC). Other suitable MOEs may include, for example, CAU-10. MIL-53, MOF-801, MOF-841 and MIL-160, See e.g., Kalmutzki et al., Adv. Mat., 30 (37), 1704304 (2018); Furukawa et al., J. Am. Chem. Soc. 2014, 136, 4369-4381. A combination of MOFs may also be used.

In some variations, the MOFs have pore sizes between about 0.5 am about 1 nm, or between about 0,7 am to about 0.9 am. In certain variations, the MOEs have a hydrophilic pore structure. In certain variations, the MOFs have a hydrophilic pore structure comprising acid and/or amine functional groups. In certain variations, the MOFs have LD channels that allow for reversible water adsorption.

In some variations, the water capture material is & microporous Aluminum Phosphate (AlPO4-LTA). See e.g. Y. Tuet al. Joule, Vol 2, Issue 8 (15), 1452-1475 (2018)

In other variations, the water capture material is a desiccant material. Any suitable desiccant material may be used.

Any combinations of the water capture materials described herein may also be used.

In some embodiments, the water capture material is mixed with a binder to improve its properties for adhesion to a substrate.

### c) Mode-Switching Structure

In some embodiments, the mode-switching structure is configured to switch at least one module from adsorption mode to desorption mode and at least one module from desorption mode to adsorption mode. In some embodiments, the mode-switching structure comprises a rotating mechanism, wherein the plurality of modules are connected to the rotating mechanism and arranged in a rotary configuration.

In certain variations, the system comprises: an adsorption/desorption unit, that has a plurality of modules containing at least one water capture material, arranged in a rotary configuration; a rotating mechanism, wherein the plurality of modules are mounted onto the rotating mechanism, and configured to switch at least one module from adsorption mode to desorption mode and at least one module from desorption mode to adsorption mode; at least one condenser, positioned in proximity to the at least one module in desorption mode, and configured to condense water vapor into liquid water; and at least one air-circulating unit, configured to draw surrounding air into each module in adsorption mode and circulate the air in the adsorption/desorption unit, thereby assisting adsorption of water by the at least one water capture material from the surrounding air. In one variation of the foregoing, the at least one condenser is positioned in the interior of the plurality of modules arranged in a rotary configuration. In one variation of the foregoing, the air drawn from surrounding air is recirculated or recycled to achieve more than one purpose, e.g., adsorbing water and cooling the condenser.

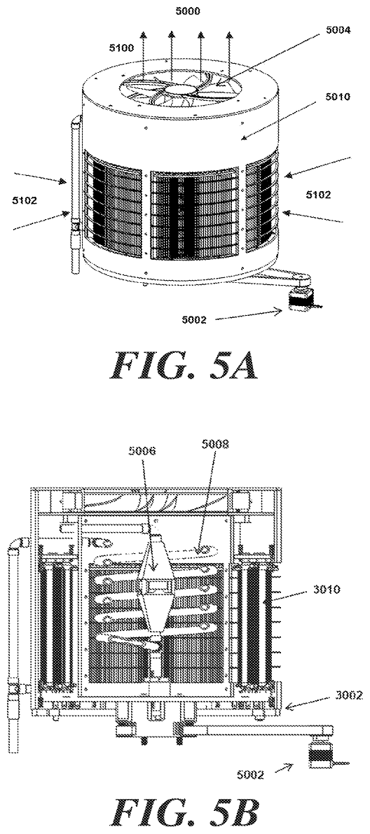

With reference to FIGS. SA and SB, depicted are two views of exemplary water harvesting system 5000 with a rotary mode-switching structure or a carousel and housing unit 5010. Air-circulating device 5004 (a fan as depicted in FIG. 5A) draws surrounding air 5102 from the side of carousel, letting the air flow through module 3010 in adsorption mode and through condenser 5008 (the condensation coil in FIG. 5B), wrapped around steam redirecting device 5006 (a condensation fan in this example) and blowing air 5100 out at the top of carousel. The cross-sectional view in FIG. SB depicts carousel 3002 including carousel motor 5002.

### Sealing Structure

In some embodiments, the water harvesting system further includes a sealing structure. configured to seal one or more modules in desorption mode. in some embodiments, the sealing structure fully or partially isolates one or more modules in desorption mode from one of more modules in adsorption mode. In some embodiments, the sealing structure is within each modole. In some embodiments, the sealing structure is external to each modole. In some embodiments, the sealing structure is partly within each module and partly external to each module.

In some embodiments, structural elements coated with water capture material are enclosed in a frame to form a module. In some embodiments, the frame or the enclosure is partly or fully sealed during desorption and open during adsorption.

### Condenser

In some embodiments, the water harvesting system further includes at least one condenser. In some embodiments, the condenser is positioned in proximity to the at least one module in desorption mode, and configured to condense water vapor into liquid water.

In some embodiments, the at least one condenser is positioned in the interior of the plurality of modules arranged in a rotary configuration.

In certain embodiments, the water harvesting system includes one or more condensers. The condenser is positioned in proximity to one or more of the modules. In some variations, multiple condensers are used. In one variation where multiple condensers are used. the condensers arranged serially or in parallel.

In some embodiments, the condenser is a tubing. In some embodiments, water vapor is condensed inside the tubing. In some embodiments, the tubing bas coil structure or is a coil of tubing. In some embodiments, the robing is cooled by circulating or blowing air around the exterior of the condenser. In some embodiments, the air circulated around or blown to the exterior of the condenser is the air used for adsorption. In some embodiments, the air circulated around or blown to the exterior of the condenser is the air cooled with cold storage. In some embodiments, the condenser is cooled with the cold side of a refrigeration cycle. In some embodiments, the condenser is an active chiller, e.g., based on refrigeration cycle or cold storage.

With reference to FIG. SC, exemplary condenser 5008 is a condensation coil, wrapped around steam-redirecting device 5006 (a condensation fan in this example). Steam-redirecting device 5006 redirects or socks water vapor or steam 5202 generated in the modules in desorption mode into condenser 5008 (the condensation coil in this example) to condense water vapor into liquid water.

With reference to FIG. 5D. after condensation, water 5200 is directed (e.g., by gravity) into float valve 5012 that allows its collection. The condensation air stream 5104 is subsequently recirculated into the module 3060 in desorption mode in order to minimize the loss of moisture and energy into the ambient air.

### Air-Circulating Unit

In some embodiments, the water harvesting system comprises at least one air-circulating unit. In some embodiments, the air-circulating unit is configured to draw surrounding air into each module in adsorption mode, thereby assisting adsorption of water by the at least one water capture material from the surrounding air.

In some embodiments, the at least one air-circulating unit is configured to simultaneously (i) draw surrounding air into the at least one module operating in adsorption mode. thereby assisting adsorption of water by the at least one water capture material in the module from the surrounding air, and (ii) circulate air to cool the at least one condenser.

### Steam-Redirecting Unit

In some embodiments, the water harvesting system comprises at least one steam-redirecting unit. In some embodiments, the steam-redirecting unit is configured to redirect water vapor desorbed from the at least one module in desorption mode to the at least one condenser. In certain variations, the steam-redirecting unit is a fan or a positive displacement pump.

### Condenser Recirculating Air Stream

In some embodiments, the water harvesting system comprises at least one recirculating unit. In some embodiments, the recirculating unit is configured to recycle the air stream exiting the condensing coil to the at least one desorption module.

### Water Collection Unit

In some embodiments. the water harvesting system comprises at least one float valve. configured to collect the condensed liquid water by gravity without any loss of air, or any substantial loss of air.

In some embodiments, the water harvesting system comprises at least one collection unit, configured to receive the liquid water. In some embodiments, the water harvesting system comprises at least one collection unit, configured to receive the liquid water exiting the at least one condenser through the at least one float valve. In some variations, the water collection unit is a storage tank.

### Control System

In some embodiments, the water harvesting system includes a control system configured to monitor and control adsorption, desorption, and condensation. In some embodiments, the control system includes one or more sensors and one or more processor units.

In some embodiments, the control system is used to increase or decrease the amount of power delivered to the modules to speed up or slow down the rate of desorption. In some embodiments, the control system is used to increase or decrease the rate at which water vapor is removed from the desorption area or modules in desorption mode and/or the rate which air is pushed into the desorption area or modules in desorption mode. In some embodiments, the control system is used to increase or decrease the amount of time that the modules spend in desorption mode. In some embodiments. the control system is used to increase or decrease the amount of time that the modules spend in the adsorption mode. In some embodiments, the control system is used to increase or decrease the rate at which air is moved across the modules during adsorption.

In some embodiments, the control system monitors and controls the water harvesting system based on environmental conditions such as temperature and humidity. In some embodiments, temperature or humidity sensors are placed inside or near the adsorption modules (modules in adsorption mode) and the desorption modules (modules in desorption mode).

In some embodiments, the control system monitors and controls the water harvesting system to maximize the total water captured over multiple adsorption and desorption cycles, as opposed to optimizing the adsorption or desorption amounts individually.

In some embodiments, a control system can be designed so that the time step for the rotation of the modules or the adsorption/desorption unit can be adjusted in such a way that (i) the time each module spends in adsorption mode before it switches to desorption mode (total adsorption time) is just enough to mostly saturate the water capture material in that module with water and (ii) the time each module spends in desorption mode before it switches to adsorption mode (total desorption time) is just enough to desorb most of the water captured by the water capture material in that module.

In some embodiments, the control system controls the speed of the steam-redirecting unit and the amount of power provided to heat the structural elements, to either speed up or slow down the desorption to match adsorption rate. Similarly, the speed of the air-circulating unit may be increased or decreased to speed up or slow down the adsorption rate to match the desorption rate. This control may be important as different temperature and humidity levels will affect the amount of the time needed for adsorption and desorption.

### Power Sources

In some variations, the systems provided herein further include one or more solar power source(s). In certain variations, the systems further include photovoltaic (PV) cells or passive solar captors, or a combination thereof.

### EXAMPLES

The following Examples are merely illustrative and are not meant to limit any aspects of the present disclosure in any way.

### Example 1

### A Water Harvesting System to Produce Drinking Water

### Water Harvesting System

A MOF layer paste, consisting of MOF powder (MOF-303 in this example) mixed with 5-15% of an organic binder, was deposited as a thin film on an electrically conductive substrate (conductive element). After coring, the MOF layer was intimately bound to the substrate, with great mechanical and thermal properties. A series of these substrates coated with MOF layer were electrically connected and assembled into modules. A small gap between the substrates allowed air to flow.

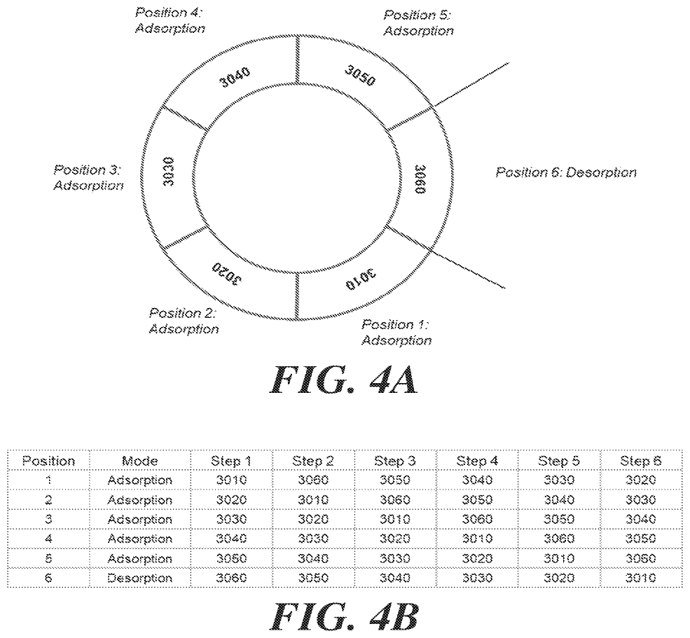

Modules were assembled in a rotary structure, called a carousel (FIGS. 3A and 3B). The carousel was constructed in such a way that one or more modules are in adsorption mode, while the other modules are in desorption mode. In this example, the carousel was composed of a total of six modules, with five modules in adsorption mode and one module in desorption mode (FIG. 4A). As the carousel rotated, modules moved from Position N to Position N+1, starting in adsorption mode, and eventually entering desorption mode (FIG. 4B).

In the modules in adsorption mode, air was sucked through the center of the structure using a central fan, and was forced between the MOF layer substrates, allowing moisture to be captured by the MOF layers (FIGS. 5A and 5B). When the module entered desorption mode, a current was passed into the substrates, heating them up (FIG. 6).

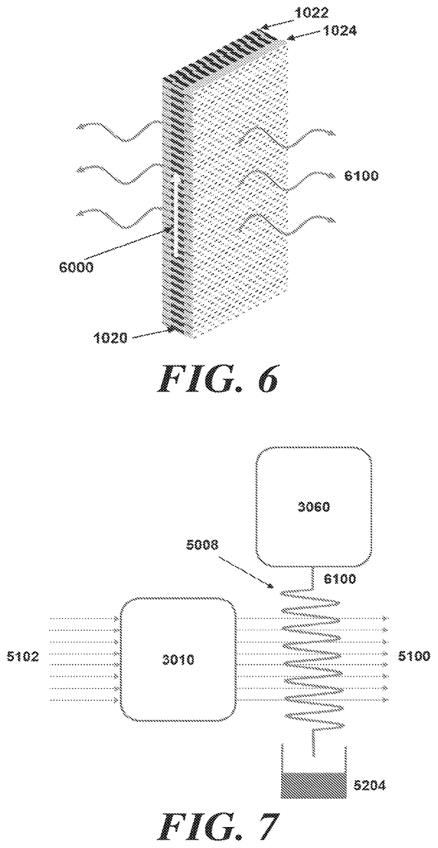

The steam that came out of the desorbing MOF layer was moved from the region of desorption to an area of condensation. In this example. the steam was socked from the module in the desorption area by a small fan and sent to a helical tube type of condenser, which was placed inside of the carousel (FIGS. 5A, 5B, and 5C). The steam was cooled to room temperature by the air flowing around the coil, causing the water to condense and flow downwards to be collected inside of a collection tank. With reference to FIG. 7, surrounding air 5102 is circulated to module(s) 3010 in adsorption mode, recirculating or recycling air 5102 to cool condenser 5008. sending out air 5100, desorbing water from module(s) 3060 in desorption mode as steam 6100, condensing steam 6100 into water with condenser 5008. and collecting water with water tank 5204.

### Results

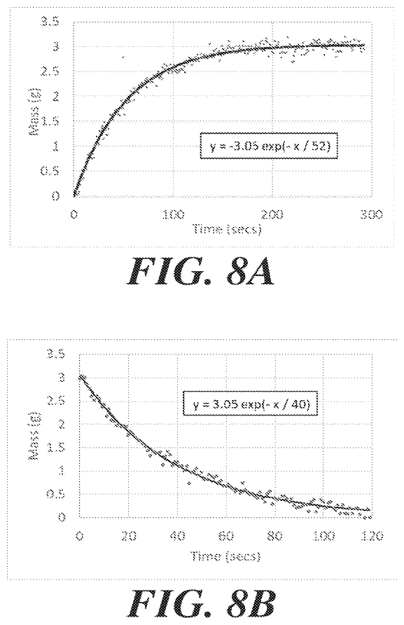

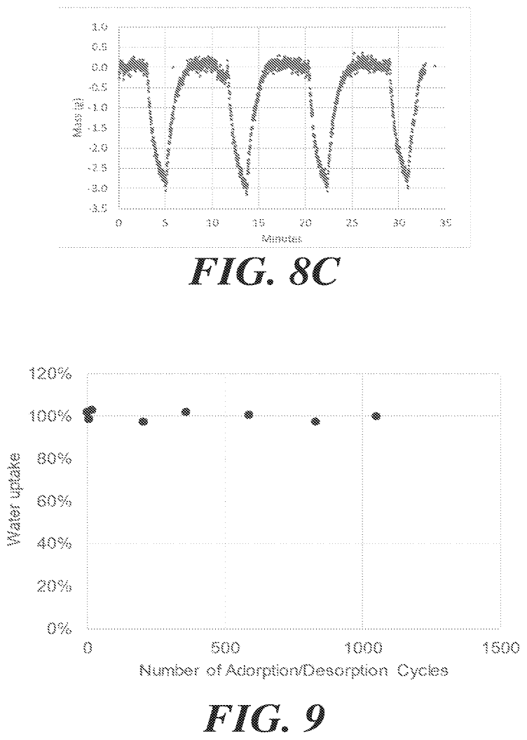

FIGS. 8A, 8B, and 8C show an example of the system performance. A module as illustrated in FIGS. 2A and 2B was placed on a precision scale. During adsorption (FIG. 8A), the weight of the module increased rapidly until about 3 grams of water was adsorbed. An exponential fit yielded a time constant of 52 seconds. During desorption (FIG. 8B), the weight of the module decreased even more rapidly, and about 3 grams of water was desorbed. An exponential fit yielded a time constant of 40 seconds. FIG. 8C shows multiple adsorption/desorption cycles, demonstrating the ability of this system to harvest water extremely efficiently. FIG. 9 shows the system reliability. After more than 1000 adsorption/desorption cycles, the water uptake is unchanged, demonstrating the excellent robustness of the system.

What is claimed is:

1. A water harvesting system for capturing water from surrounding air, comprising:
an adsorption/desorption unit, comprising:
a plurality of modules, configured such that at least one module operates in adsorption mode concurrently as at least one of the remaining modules operates in desorption mode.
wherein each module comprises at least one structural element,
wherein at least a portion of each structural element supports at least one water capture material,
wherein the at least one water capture material adsorbs water from surrounding air when the module is in adsorption mode, and desorbs water in the form of water vapor when the module is in desorption mode,
a mode-switching structure, configured to concurrently switch at least one module from adsorption mode to desorption mode and at least one module from desorption mode to adsorption mode;
at least one condenser, positioned in proximity to the at least one module in desorption mode, and configured to condense water vapor into liquid water; and
at least one air-circulating unit, configured to draw surrounding air into each modole in adsorption mode, thereby assisting adsorption of water by the at least one water capture material from the surrounding air.

2. The system of claim 1, wherein the mode-switching structure comprises a rotating mechanism, wherein the plurality of modules are connected to the rotating mechanism and arranged in a rotary configuration.

3. The system of claim 1 or 2, further comprising at least one steam-redirecting unit. configured to redirect water vapor desorbed from the at least one module in desorption mode to the at least one condenser.

4. The system of any one of claims 1 to 3, wherein each module further comprises a frame to hold together the structural elements.

5. A water harvesting system for capturing water from surrounding air, comprising:
an adsorption/desorption unit, comprising:
at least one structural element,
wherein at least a portion of each structural element supports at least one water capture material.
wherein the at least one water capture material adsorbs water from surrounding air when in adsorption mode, and desorbs water in the form of water vapor when in desorption mode;
at least one condenser, positioned in proximity to the at least one structural element, and configured to condense water vapor into liquid water; and
at least one air-circulating unit, wherein the at least one air-circulating unit is configured to simultaneously (i) draw surrounding air into the at least one module operating in adsorption mode, thereby assisting adsorption of water by the at least one water capture material in the module from the surrounding air, and (ii) circulate air to cool the at least one condenser.

6. The system of any one of claims 1 to 5, wherein the at least one structural element is a conductive element.

7. The system of any one of claims 1 to 6, wherein the adsorption/desorption unit is configured to directly heat the at least one structural element and minimize waste heat.

8. The system of any one of claims 1 to 6, further comprising at least one heat exchange manifold connected to, or positioned around, the at least one structural element.

9. The system of any one of claims 1 to 8, wherein the at least one structural element is at least one plate.

10. The system of claim 9, wherein the at least one places are arranged radially or parallel to each other within the module.

11. A water harvesting system for capturing water from surrounding air, comprising:
an adsorption/desorption unit, comprising:
a plurality of modules arranged in a rotary configuration, wherein each module comprises at least one conductive element,
wherein at least a portion of each conductive element is coated with at least one water capture material,
wherein the at least one water capture material adsorbs water from surrounding air when the module is in adsorption mode, and desorbs water in the form of water vapor when the module is in desorption mode;
a rotating mechanism, wherein the plurality of modules are mounted onto the rotating mechanism, and configured to concurrently switch at least one module from adsorption mode to desorption mode and at least one modole from desorption mode to adsorption mode:
at least one condenser, positioned in proximity to the at least one module in desorption mode, and configured to condense water vapor into liquid water; and
at least one air-circulating unit, configured to draw surrounding air into each module in adsorption mode and circulate the air in the adsorption/desorption unit, thereby assisting adsorption of water by the at least one water capture material from the surrounding air.

12. The system of claim 11, further comprising at least one steam-redirecting unit, configured to redirect water vapor desorbed from the at least one module in desorption mode to the at least one condenser.

13. The system of claim 11 or 12, wherein the at least one condenser is positioned in the interior of the plurality of modules arranged in a rotary configuration.

14. The system of any one of claims 1 to 13, wherein the at least one conductive element is at least one metal plate.

15. The system of claim 14, wherein the at least one metal plates are arranged radially or parallel to each other within the module.

16. The system of any one of claims 1 to 15, wherein the at least one water capture material comprises metal organic framework.

17. The system of any one of claims 1 to 15, wherein the at least one water capture material comprises desiccant material.

18. The system of any one of the preceding claims, further comprising a sealing structure, configured to seal one or more modules in desorption mode.

19. The system of any one of the preceding claims, further comprising at least one collection unit. configured to receive the liquid water from the at least one condenser.

20. The system of any one of the preceding claims, further comprising a control system configured to monitor and control adsorption, desorption and condensation, wherein the control system comprises: at least one sensor: and at least one processor unit.

21. The system of any one of the preceding claims, wherein an air stream exits the at least one condenser, and the system further comprises at least one recirculating unit, configured to recycle the air stream exiting the at least one condenser to at least one module in desorption mode.

22. The system of any one of the preceding claims. further comprising at least one float valve. configured to collect the liquid water by gravity without any substantial loss of air.

23. The system of claim 22, further comprising at least one collection unit, configured to receive the liquid water exiting the at least one condenser through the at least one float valve.

24. The system of any one of the preceding claims, further comprising at least one housing unit to hold the adsorption/desorption unit, at least one condenser and at least one air circulating unit.

25. A method of harvesting water from surrounding air using a water harvesting system of any one of claims 1 to 3 and 17 to 24, comprising:
a) adsorbing water from surrounding air in at least one module in adsorption mode;
b) desorbing at least a portion of water in at least one of the remaining modules in desorption mode;
c) condensing at least a portion of the water vapor release from the at least one module in desorption mode using the at least one condenser to produce liquid water. wherein steps (a)-(c) occur concurrently; and
d) switching at least one module in adsorption mode to desorption mode and at least one of the remaining modules in desorption mode to adsorption mode.

26. A method of harvesting water from surrounding air using a water harvesting system of any one of claims 4 to 9 and 17 to 24, comprising:
a) drawing surrounding air into at least one module in adsorption mode to assist adsorption of water by the at least one water capture material and to assist cooling of the at least one condenser, wherein the air is recirculated or recycled to assist with adsorption and cooling;
b) heating at least one of the remaining modules in desorption mode to assist desorption of at least a portion of water from the at least one water capture material; and
c) condensing at least a portion of the water vapor release from the at least one module in desorption mode using the at least one condenser to produce liquid water.

27. A method of harvesting water from surrounding air using a water harvesting system of any one of claims 10 to 24, comprising:
a) adsorbing water from surrounding air in at least one module in adsorption mode:
b) desorbing at least a portion of water in at least one of the remaining modules in desorption mode;
c) condensing at least a portion of the water vapor release from the at least one module in desorption mode using the at least one condenser to produce liquid water, wherein steps (a)-(c) occur concurrently; and
d) rotating at least one module in adsorption mode to desorption mode and at least one of the remaining modules in desorption mode to adsorption mode.

28. The method of any one of claims 25 to 27, wherein an air stream exits the at least one condenser, and the method further comprises recycling the air stream exiting the at least one condenser to the at least one module in desorption mode.
